(19) United States
(12) Patent Application Publication
(10) Pub. No.: US 2004/0215502 A1
(43) Pub. Date: Oct. 28, 2004

(54) Evaluation apparatus and evaluation method

(75) Inventors: Masamichi Takahashi, Kanagawa (JP); Masakazu Fujimoto, Kanagawa (JP); Nobuhiro Yamasaki, Kanagawa (JP); Hiroyuki Hattori, Kanagawa (JP); Hiroko Onuki, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/762,471

(22) Filed: Jan. 23, 2004

(30) Foreign Application Priority Data
Jan. 27, 2003 (JP) 2003-017022
Sep. 17, 2003 (JP) 2003-324272

(51) Int. Cl. G06F 17/60

(52) U.S. Cl. 705/10

(57) ABSTRACT

An analysis and evaluation apparatus conducts a survey by questionnaire of the members of organizations, and extracts from the responses to the questionnaire common words (attributes) for each organization or for each member. The analysis and evaluation apparatus compares the attribute to be evaluated with a common word and concept for an organization or a member, and analyzes the range and the level that the attribute to be evaluated provides for the influence for the organization. In this manner, the evaluation of the organization or the member is performed. Further, the analysis and evaluation apparatus performs a statistical analysis and a time-series analysis for the evaluation results, and stores or outputs the evaluation results and the analysis results.

### BACKGROUND OF THE INVENTION

1. Field of the Invention

The present invention relates to an evaluation apparatus and an evaluation method for evaluating, based on research results obtained for information propagated among a plurality of organizations, how one organization has influenced another organization.

2. Description of the Related Art

Nowadays, emails, mailing lists for email systems, and electronic bulletin board systems using the WWW (World Wide Web) are commonly used as organizational communication means that employ an information technology (IT).

Since messages to be propagated by these organizational communication means are stored in message logs, these messages can be analyzed, and the results can be used.

An email in message logs includes a body part and a header part that indicates a title, a sender (poster) and date. In JP-A-11-242545, for example, there is disclosed a message searching system that enables search by a natural-language from message logs.

As another example, in JP-A-6-059993 a method is disclosed whereby data included in a header are used for network management (the analysis of a routing delay, and the storage of a log).

As an additional example, in JP-A-6-259345, in JP-A-11-015757, and in JP-A-6-062046, a method is disclosed whereby data included in a header are used for an agent process (the sorting of emails) performed on a reception side.

However, the system and the methods disclosed in these documents are not designed to provide for an evaluation, using accumulated message logs, of the extent and the strength to which one organization influences others.

Therefore, by using any of the systems and the methods, it is not possible to objectively perform an evaluation to determine how a specific organization influences other organizations.

On the other hand, there is proposed a method for analyzing a message log from the viewpoint of organizational communication means, and the usefulness of the method is discussed academically (see documents: “Advances in social network analysis: Research in the social and behavioral sciences, pp. 167-203, Newbury Park, Calif.: Sage, 1996 ACM 0-89791-782-0/96/04, JCMC 3(4) June 1998”; and “Work group structures and computer support: A field experiment, pp. 324-343, Portland, Oreg., United States, 1988 ACM 0-89791-282-9/88/0324”).

However, the analysis method proposed in the above documents is not a method to be used for evaluating the value of a specific organization, such as a company, among a set of organizations. Further, for the analysis, a method is not disclosed for automatically performing the process proceeding from the acquisition of a message log to the analysis of the organizational communication.

In addition, there is known a method for analyzing a message log of organizational communication, and visualizing information representing the result among posters (see document: “Takahashi, Kitayama and Kaneko: Weighing and visualizing organization awareness in network communications, Bulletin of Information Processing Institute, Vol. 40, No. 11, pp. 3988-3999, November 1999”).

Further, in JP-A-10-301905, a method is disclosed for analyzing a message log in order to use relationship information in common.

Furthermore, there is known a method for employing relationship information to calculate various indicators including an indicator for visualization.

However, according to the methods disclosed in the above documents, merely organizational communications are visualized, and an evaluation of the value of an organization is not performed.

### SUMMARY OF THE INVENTION

The present invention has been made to provide an evaluation apparatus and an evaluation method for analyzing messages propagated within an organization and between organizations, and for objectively evaluating the values obtained for the organizations.

In order to achieve the object, according to a first aspect of the invention, there is provided an evaluation apparatus for evaluating activities of a plurality of groups to be evaluated, the apparatus including: an inquiry unit configured to direct inquiries to the plurality of groups concerning activities, each of the activities include one or more attributes, performed by the groups; an attribute analysis unit configured to examine activity data included in responses received from the plurality of groups to which inquiries were directed, to analyze attributes that are used for the activities by the plurality of groups, and to generate attribute data that represent the attributes obtained as the result of the analysis; and an evaluation unit configured to evaluate, based on the activity data and the attribute data, values of the activities, the attributes and the groups, or the values of one or more arbitrary combinations of the activities, the attributes and the groups.

According to a second aspect of the invention, there is provided an evaluation method for evaluating the activities of a plurality of groups including: directing inquiries to the plurality of groups concerning activities, each of which includes one or more attributes and is performed by a group; examining activity data that, in response to the inquiries, are included in responses received from the plurality of groups; analyzing the attributes that are used for the activities performed by the plurality of groups; generating attribute data that represent the attributes obtained by the analysis results; and evaluating, based on the activity data and the attribute data, the values of the activities, the attributes and the groups, or the values of one or more arbitrary combinations of the activities, the attributes and the groups.

According to a third aspect of the invention, there is provided a program for computer to evaluate activities of a plurality of groups to be evaluated, the program making the computer to perform a process including: directing inquiries to the plurality of groups concerning activities, each of which includes one or more attributes and is performed by a group; examining activity data that, in response to the inquiries, are included in responses received from the plurality of groups; analyzing the attributes that are used for the activities performed by the plurality of groups; generating attribute data that represent the attributes obtained by the analysis results; and evaluating, based on the activity data and the attribute data, the values of the activities, the attributes and the groups, or the values of one or more arbitrary combinations of the activities, the attributes and the groups.

### BRIEF DESCRIPTION OF THE DRAWINGS

The above objects and advantages of the present invention will become more apparent by describing in detail of a preferred embodiment thereof with reference to the accompanying drawings, wherein:

FIG. 1 is a diagram showing an example configuration for a network system for which an evaluation method according to the present invention is applied;

FIG. 2 is a diagram showing the hardware configuration for a client computer, a server and an analysis and evaluation apparatus shown in FIG. 1;

FIG. 3 is a diagram showing the structure of a client program that is executed by the client computer shown in FIGS. 1 and 2;

FIG. 4 is a diagram showing the structure of a server program that is executed by the server shown in FIGS. 1 and 2;

FIG. 5 is a diagram showing the structure of an analysis and evaluation program that is executed by the analysis and evaluation apparatus shown in FIGS. 1 and 2;

FIG. 6 is a diagram showing organization information stored in an organization and member DB shown in FIG. 5;

FIG. 7 is a diagram showing a specific example for the organization information shown in FIG. 6;

FIG. 8 is a diagram showing personal information stored in the organization and member DB in FIG. 5;

FIG. 9 is a diagram showing a specific example of the personal information shown in FIG. 8;

FIG. 10 is a diagram showing example survey result information, related to an activity, and is stored in a survey result DB by a survey unit;

FIG. 11 is a diagram showing example survey result information, related to data propagation, and is stored in the survey result DB by the survey unit;

FIG. 12 is a diagram showing example survey result information, related to a psychological activity, and is stored in the survey result DB by the survey unit;

FIG. 13 is a diagram showing example survey result information that is obtained by asking each member of an organization system shown in FIG. 1 a plurality of questions and that is stored in the survey result DB by the survey unit;

FIG. 14 is a diagram showing a correspondence of the survey result information shown in FIGS. 10 through 12 with a respondent;

FIG. 15 is a first diagram showing example intra-organizational common word information that is stored in an analysis and evaluation result DB by an analysis and evaluation unit in FIG. 5;

FIGS. 16A through 16C are diagrams showing specific examples of the common word information in FIG. 15;

FIG. 17 is a second diagram showing example intra-organizational common word information that is stored in the analysis and evaluation result DB by the analysis and evaluation unit in FIG. 5;

FIG. 18 is a diagram showing a specific example of a common concept shown in FIG. 17;

FIG. 19 is a first diagram showing example intra-organizational common word information, including a concept, that is stored in the analysis and evaluation result DB by the analysis and evaluation unit in FIG. 5;

FIG. 20 is a second diagram showing example intra-organizational common word information, including a concept, that is stored in the analysis and evaluation result DB by the analysis and evaluation unit in FIG. 5;

FIG. 21 is a flowchart showing the matching processing (S50) performed by the analysis and evaluation unit to extract a common concept from the survey result information shown in FIGS. 10 through 12;

FIG. 22 is a first diagram showing example member-based common word information that is stored in the analysis and evaluation result DB by the analysis and evaluation unit in FIG. 5;

FIG. 23 is a second diagram showing example member-based common word information that is stored in the analysis and evaluation result DB by the analysis and evaluation unit in FIG. 5;

FIG. 24 is a first diagram showing example influence evaluation results that are stored in the analysis and evaluation result DB by the analysis and evaluation unit in FIG. 5;

FIG. 25 is a diagram showing a specific example of an extent of influence shown in FIG. 24;

FIG. 26 is a diagram showing an example strength of influence;

FIG. 27 is a flowchart showing the processing (S52) for calculating the extent of influence in FIG. 24;

FIG. 28 is a flowchart showing the processing (S54) for calculating the strength of influence shown in FIG. 27;

FIG. 29 is a second diagram showing example influence evaluation results that are stored in the analysis and evaluation result DB by the analysis and evaluation unit in FIG. 5;

FIG. 30 is a diagram showing a specific example of the extent of influence obtained for each concept;

FIG. 31 is a diagram showing a specific example of the strength of influence obtained for each concept;

FIG. 32 is a first diagram showing example evaluation results for the influence that the concept has on an organization or a member;

FIG. 33 is a second diagram showing example evaluation results for the influence that the concept has on an organization or a member;

FIG. 34 is a third diagram showing example evaluation results for the influence that the concept has on an organization or a member;

FIG. 35 is a diagram showing the analysis and evaluation sequence (S30) performed by a network system; and

FIG. 36 is a flowchart showing the analysis and evaluation processing (S40) in FIG. 35 performed by the analysis and evaluation unit (FIG. 5).

### DETAILED DESCRIPTION OF THE PREFERRED EMBODIMENT

In order to easily understand the present invention, an overall concept of the present invention will be described prior to describing the details of the preferred embodiment of the invention.

Hereinafter, in this description, the words “propagation” and “propagate” are used as a same meaning as the words “transmission” and “transmit”.

The value of an organization (unconcerned with whether an organization is a substantial one, such as the a department of a company, or a virtual one, such as an mailing list) is conventionally evaluated through an official trading performed between a specific organization and an organization external to the specific organization, through services provided to the external organization, or through earnings from the external organization.

For example, for a company, organizations are hierarchically organized by functions to resolve problems and each problem is resolved by propagating an order to the corresponding organization.

Conventionally, in this system for a company, the value of one organization is evaluated, for example, as a difference and a ratio between the input of resources, such as persons, things and money, to the organization for its own sake and the output, such as an economical value or a service provided as a result.

However, both from the academic aspect and the actual business aspect, it has been pointed out that the value of an organization cannot be fully evaluated merely from the viewpoint of the difference and the ratio between the input and the output.

Further, for a field such as business administration, it is also pointed out that the method for resolving the problem using the hierarchical organization cannot rapidly cope with a variety of client demands.

To handle these points, one proposal is provided whereby a flat structure is used for the organizations within a company by the introduction of IT (Information Technology), and thereafter, self-controlled and decentralized activities are recommended to the member organizations, and in order to resolve problems, the distribution of resources is flexibly changed and optimized.

However, when the flat structure is used for organizations, it is extremely difficult for the values of the organizations and their members to be evaluated based on the difference and the ratio between the input and the output.

The reason for this, as is described above, is that since the flat structure for the organizations can be flexibly changed, originally an organization is not formed in order to resolve a specific problem. Further, the members of the organization may be constantly changed, so that one member may belong to a plurality of organizations, officially or unofficially. Furthermore, after the problem has been resolved, the organization is dispersed. Therefore, it is difficult to evaluate the input directed to and the output provided by an organization.

According to the present invention, intra-organizational or inter-organizational communication is focused on, regardless of whether it is official or unofficial.

Specifically, according to the invention, in order to evaluate a value for an organization, the focus is on what kind of communication contents originating (performed) at a specific organization are used by another organization and in what range or scale.

When this point is focused on, it is possible to alternatively evaluate the value of an organization that performs an activity that generates some indirect economic value, or one for which evaluation is difficult, such as the provision of information and a service that are not officially the responsibility of the organization, and the value of the communications within the organization.

More specifically, when the focus is on the analysis of the contents of communications originating at a specific organization, while the organization is resolving a problem, and information concerning the organization is propagated to another organization and its members, or is used for the activities of another organization and its members, the difference between the value of the specific organization and the value of the communications within the organization can be evaluated.

For example, it is not only possible to correctly and objectively evaluate the value to a company of a department that actually attains a profit, but also the value to the company of a department that seems less valuable because, although it achieves no profits, it actually benefits many other departments in the company and indirectly contributes to the realization of a large profit. Therefore, from this viewpoint, understanding the value to the company of all organizations is an effective means for appropriately distributing investments and budgets, and can contribute to the performance results attained by the company.

In the present invention, by analyzing the communications within an organization, the objective value of the organization can be evaluated.

Example means (media) for organizational communication can be oral means, telephones, video telephone systems and computer networks (e.g., emails, electronic bulletin board systems, chat rooms and instant messaging).

To achieve the present invention, it is assumed that communications performed through these media are surveyed and aggregated.

For this survey, methods are available for distributing questionnaire forms for all the organizations, and for entering responses by manually filling in the forms using an analysis and evaluation apparatus, or by using OCR (Optical Character Reader apparatus), and a method whereby, using a web page, an analysis and evaluation apparatus issues questions on line to the members of organizations and collects their responses.

In order to embody and simplify the explanation, hereinafter the second method is used by a company, i.e., the conduct of a questionnaire survey using a web page.

To perform a questionnaire survey using a web page, members of an organization answer to the questions by filling in the form that a web server displays on the browsers of computers in text, or by choosing alternatives that have been prepared in advance.

At this time, the web server can automatically add, to the responses, identification information for members and response dates that are required for the analysis and the evaluation of the responses, or the members can add these data to the responses through specific operations involving the use of the form on the browsers.

[Embodiment]

Hereinafter, one embodiment of the present invention will now be described.

[Network System 1]

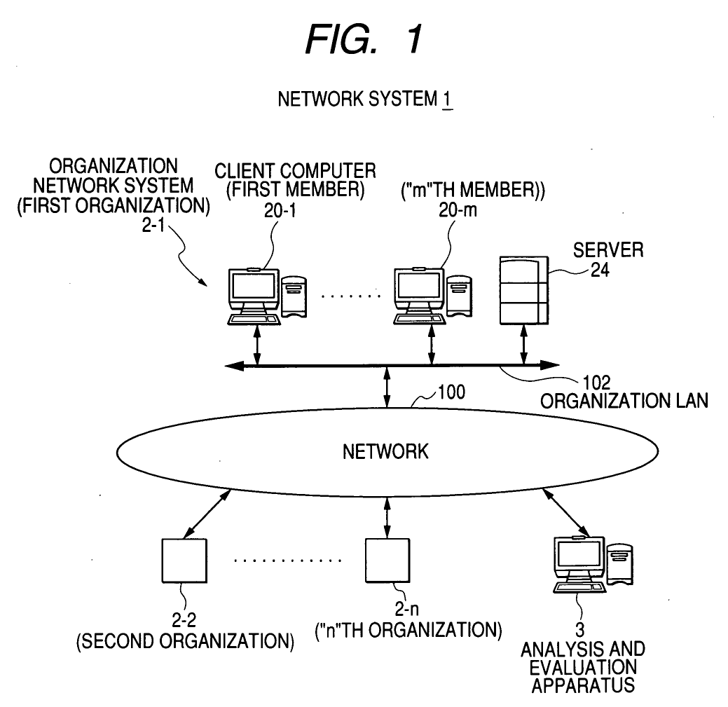

FIG. 1 is a diagram showing an example configuration for a network system for which an evaluation method according to the invention is applied.

The network system 1 is, for example, a wide area network (WAN) spanning a plurality of offices in the same company. As is shown in FIG. 1, a plurality of organizations (first to “n”th organizations) to be evaluated, organization systems 2-1 to 2-n (n≧2) that are used for the member organizations, and an analysis apparatus 3 are interconnected via a network 100.

Hereinafter, a plurality of components, such as the organization systems 2-1 to 2-n, are described simply as the organization system 2, unless a specific system is designated.

As an example configuration for the organization system 2, client computers 20-1 to 20-m (m≧1), each used by members (constituted by “m” members) of an organization, are connected to a server 24 by an organization LAN 102 spanning all computers in the organization.

[Hardware Arrangement]

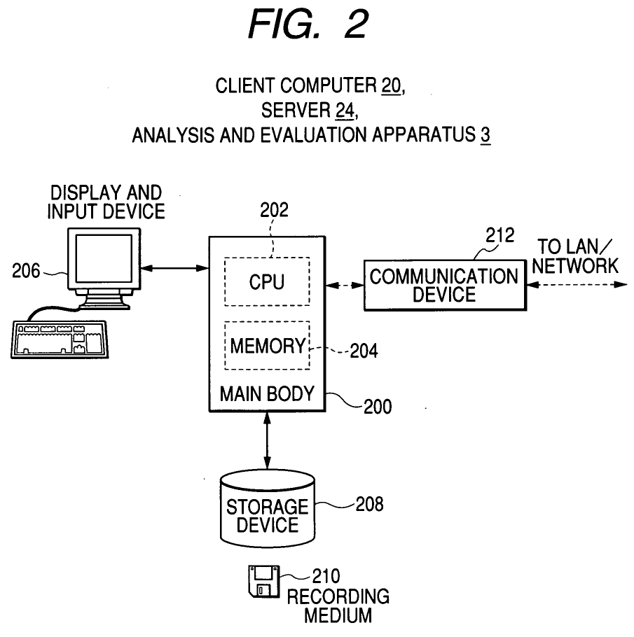

FIG. 2 is a diagram showing a hardware arrangement for the client computer 20, the server 24 and the analysis and evaluation apparatus 3 shown in FIG. 1.

As is shown in FIG. 2, the client computer 20, the server 24 and the analysis and evaluation apparatus 3 each include: a main body 200, including a CPU 202 and a memory 204; display and input devices 206, including a keyboard and a mouse (not shown); a storage device 208, such as an HDD or a CD drive; and a communication device 212, which uses the organization LAN 102 to communicate with the network 100.

That is, included in the client computer 20, the server 24 and the analysis and evaluation apparatus 3 are components for a common computer that can perform network communication.

[Client Program 22]

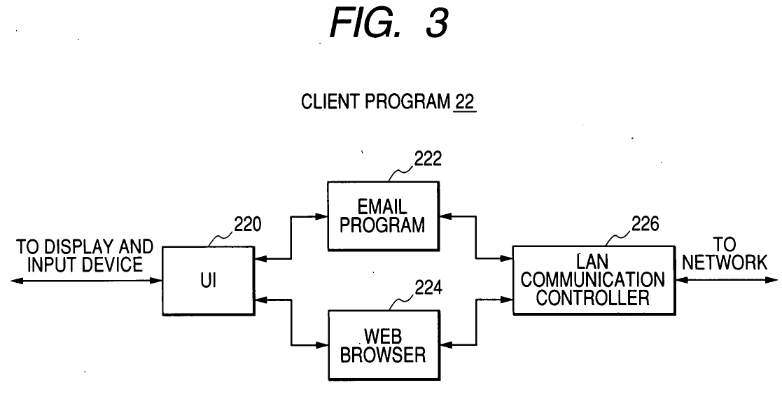

FIG. 3 is a diagram showing the structure of a client program 22 that is executed by the client computer 20 shown in FIGS. 1 and 2.

As is shown in FIG. 3, included in the client program 22 are a user interface (UI) unit 220, an email program 222, a web browser 224 and a LAN communication controller 226.

The client program 22, which is stored on a recording medium 210, for example, that is provided for the storage device 208 of the client computer 20, is loaded into the memory 204 and executed.

With these components in FIG. 3, the client program 22 provides an email propagation/reception function and a WWW browsing function for the members (users) of an organization that employs the client computer 20.

The UI unit 220 of the client program 22 accepts an entry by a user through the display and the input device 206 (FIG. 2), and controls the processes performed by the member components of the client program 22.

Further, for a user, the UI unit 220 displays emails received by the email program 222 and data obtained from the WWW by the web browser 224.

The email program 222 provides the email propagation/reception function for the user of the client computer 20.

The LAN communication controller 226 controls communication, through the organization LAN 102 (FIG. 1) and the network 100, with another client computer 20 in the same organization or the server 24 (the component acting as the main communication body is also generally referred to as a communication node) and communication with the communication node of another organization.

The web browser 224 provides the WWW browsing function for the user of the client computer 20.

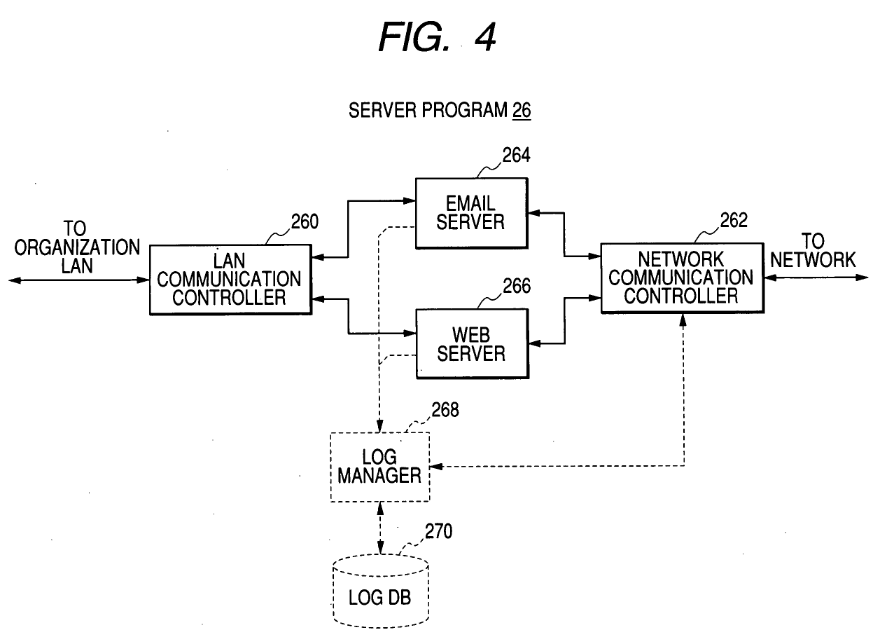

When the questionnaire based survey for organizational communication is conducted, the web browser 224 displays, on the display and input device 206, questions that are received from a web server 266 (will be described later while referring to FIG. 4) of the server 24 and that are required for the organizational communication survey, and presents these questions to each user (each of the members of the first to the “m”th member).

When each of the members employs the display and input device 206 to enter answers to the questions displayed on the browser, the web browser 224 accepts the answers and propagates them to the analysis and evaluation apparatus 3.

[Server Program 26]

FIG. 4 is a diagram showing the structure of a server program 26 executed by the server 24 shown in FIG. 2.

As is shown in FIG. 4, the server program 26 includes a LAN communication controller 260, a network communication controller 262, an email server program 264 and the web server 266.

Furthermore, as indicated by broken lines in FIG. 4, a log manager 268 and a log database (log DB) 270 are additionally included, as needed, in the server program 26.

The server program 26, as well as the client program 22 (FIG. 3), is supplied from the recording medium 210 (FIG. 1) to the storage device 208 in FIG. 2) of the server 24, loaded into the memory 204 and executed.

With the components shown in FIG. 4, the server program 26 provides an email server function for the client computers 20 (members) belonging to the same organization system 2 (organization), and provides a WWW server function for the client computers 20 (members) of the same or a different organization system 2 (organization).

The LAN communication controller 260 of the server program 26 controls communications with the organization LAN 102 (FIG. 1).

The network communication controller 262 controls communications with the network 100.

And the email server program 264 performs the email server function.

The web server 266 performs the WWW server function.

And when the questionnaire based organizational communication survey is conducted, the web server 266 uses the web browser 224, operated by the client computer 20, to display on the display and input device 206 (FIG. 2) questions that are received from the analysis and evaluation apparatus 3 (FIG. 1) and are required for the survey.

When each of the members 1 to m has used the display and input device 206 to enter answers to the questions displayed on the browser, the web server 266 propagates to the analysis and evaluation apparatus 3 a response (will be described later) containing the answers input by the members.

In accordance with control data received from the analysis and evaluation apparatus 3 via the network communication controller 262, the log manager 268 records, in the log DB 270, a message log for the communications performed by the email server program 264 and the web server 266.

Further, as needed, the log manager 268 propagates the message log stored in the log DB 270 to the analysis and evaluation apparatus 3.

[Analysis And Evaluation Program 34]

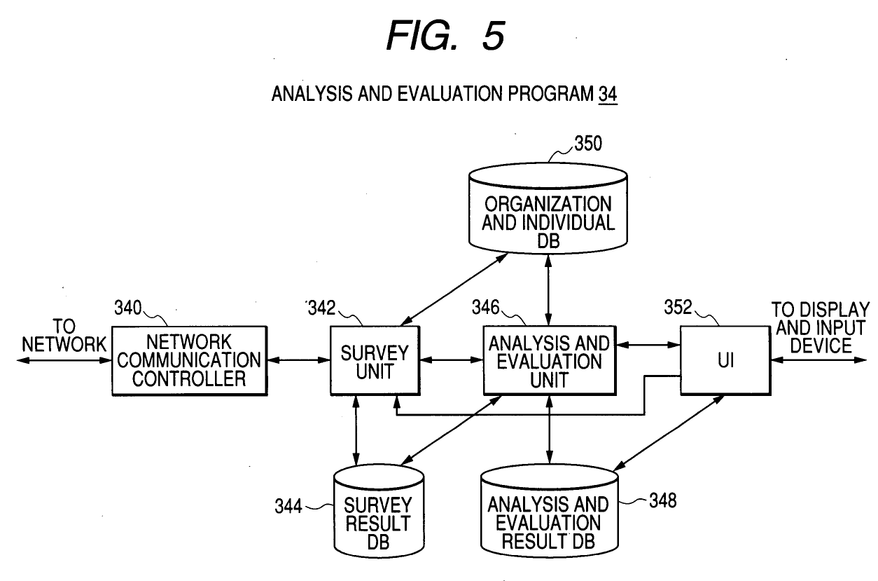

FIG. 5 is a diagram showing the structure of an analysis and evaluation program 34 that is executed by the analysis and evaluation apparatus 3 shown in FIGS. 1 and 2.

As is shown in FIG. 5, the analysis and evaluation program 34 includes a network communication controller 340, a survey unit 342, a survey result DB 344, an analysis and evaluation unit 346, an analysis and evaluation result DB 348, an organization and member DB 350 and a UI unit 352.

The analysis and evaluation program 34, as well as the client program 22 (FIG. 3) and the server program 26 (FIG. 4), is supplied from the recording medium 210 to the storage device 208 of the analysis and evaluation apparatus 3 and is loaded into the memory 204 and executed.

With these components in FIG. 5, the analysis and evaluation program 34, which uses the web browser 224 of the client program 22 (FIG. 3) that is operated by the client computer 20 (FIG. 1) of each of the organization systems 2, displays questions that are required for the questionnaires for the organizational communication survey, and receives answers to the questions from the members of the system.

Furthermore, to analyze how a specific organization or member has influenced other organizations or members, the analysis and evaluation program 34 examines the answers and evaluates the value of the specific organization or member.

Further, by employing the same analysis and evaluation performed for the answers, the analysis and evaluation program 34 analyzes how a specific word and its concept (there are networks and ontology for words, sentences and meanings; words are one example) influence an organization and its members, and evaluates the values of the word and the concept.

The evaluation method of the invention can also be used using emails; however, in the description of the embodiment, an example is used wherein the value of an organization is evaluated based on the questionnaire survey performed using web pages.

The network communication controller 340 of the analysis and evaluation program 34 controls communication with the network 100.

The UI unit 352 accepts a user entry from the display and input device 206, and controls the processes performed by the member sections of the analysis and evaluation program 34.

In addition, in accordance with an operation performed by a user, the UI unit 352 displays on the display and input device 206 the log stored in the survey result DB 344, and the analysis results and evaluation results stored in the analysis and evaluation result DB 348.

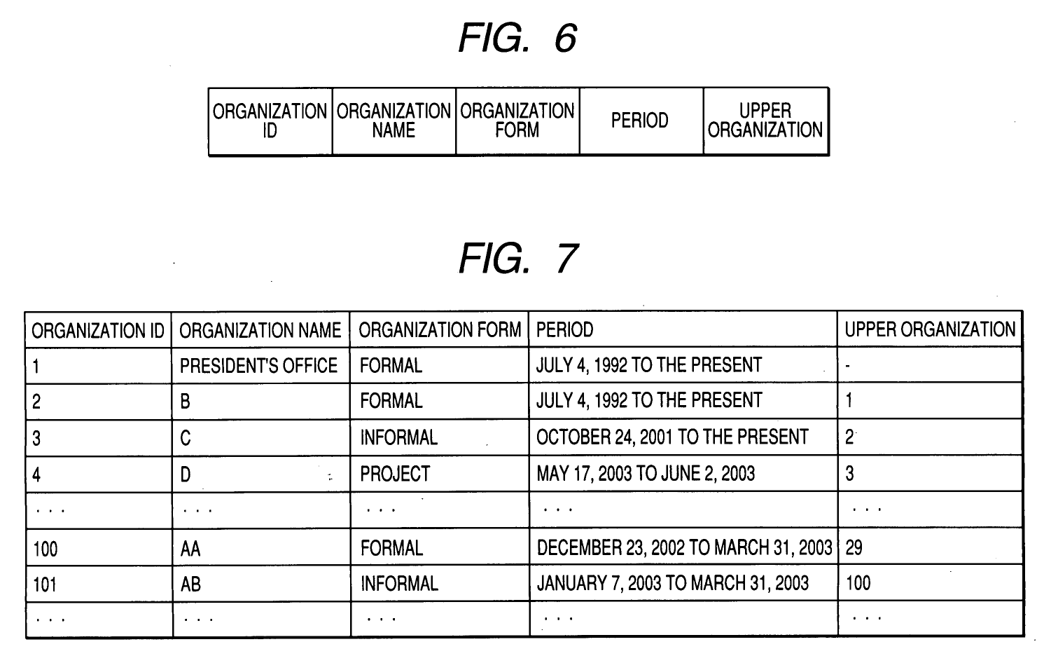

FIG. 6 is a diagram showing organization information stored in the organization and member DB 350 in FIG. 5.

FIG. 7 is a diagram showing a specific example of the organization information in FIG. 6.

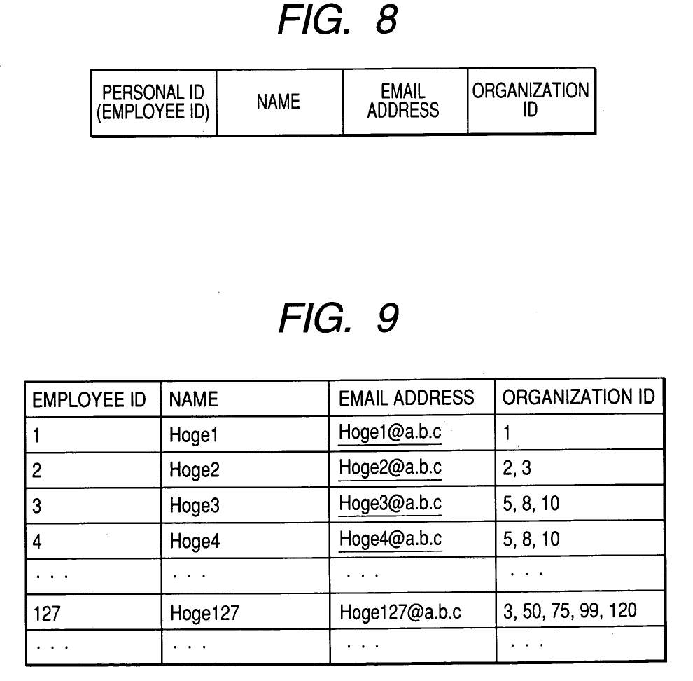

FIG. 8 is a diagram showing personal information stored in the organization and member DB 350 in FIG. 5.

FIG. 9 is a diagram showing a specific example of the personal information in FIG. 8.

Stored in the organization and member DB 350 are organization information (FIGS. 6 and 7) for the organizations 1 to n (FIG. 1) that employ the organization systems 2-1 to 2-n, and personal information (FIGS. 8 and 9) for the members (of the first to the “m”th members) of the organizations (of the first to the “n”th organizations).

As is shown in FIGS. 6 and 7, in, the organization and member DB 350, identifiers (organization IDs) for identifying each of the organizations, organization names, organization forms, periods (existence periods) for the organization existence, and upper organizations (when such are present for the organization), are stored as organization information for each of the organizations.

Further, as is shown in FIGS. 8 and 9, in the organization and member DB 350, identifiers (personal IDs or employee IDs) for identifying each of the members, the names and email addresses of the members, and the organization IDs (FIGS. 6 and 7) of the organizations to which each of the members belong are stored as personal information for each of the members of the organizations.

For the organizations shown in a conventional organizational tree, “formal” is entered in the columns of the organization forms for the organization information shown in FIGS. 6 and 7.

Further, “semi-formal” is entered for cross-sectional groups, which are not shown in the organization chart, to exchange information through backstairs gossip or by using a mailing list.

In addition, “project” is entered for groups that perform cross-sectional activities within a specified duration.

The organization ID is uniquely correlated with each organization and is used to indicate correspondence thereof with an upper organization.

The organization name is the name used in the organization chart, or the name of an informal or project organization.

The existence period for the organization represents a period extending from the start of the organization to the end.

In the columns of the organization forms shown in FIGS. 6 and 7, organization attributes (e.g., normal organizations, projects, communities) are entered for formal organizations shown in the organizational tree of a company, a cross-sectional project organization constituting a plural formal organizations to achieve a specific objective, an organization such as a community based on voluntary participation, and a group having the same interests and sharing information.

Further, the organization information shown in FIGS. 6 and 7 may include information about clients in charge of organizations, missions, and sales records and targets.

The personal information shown in FIGS. 8 and 9 may include information about clients in charge of employees (members) and carrier plans.

[Survey Unit 342]

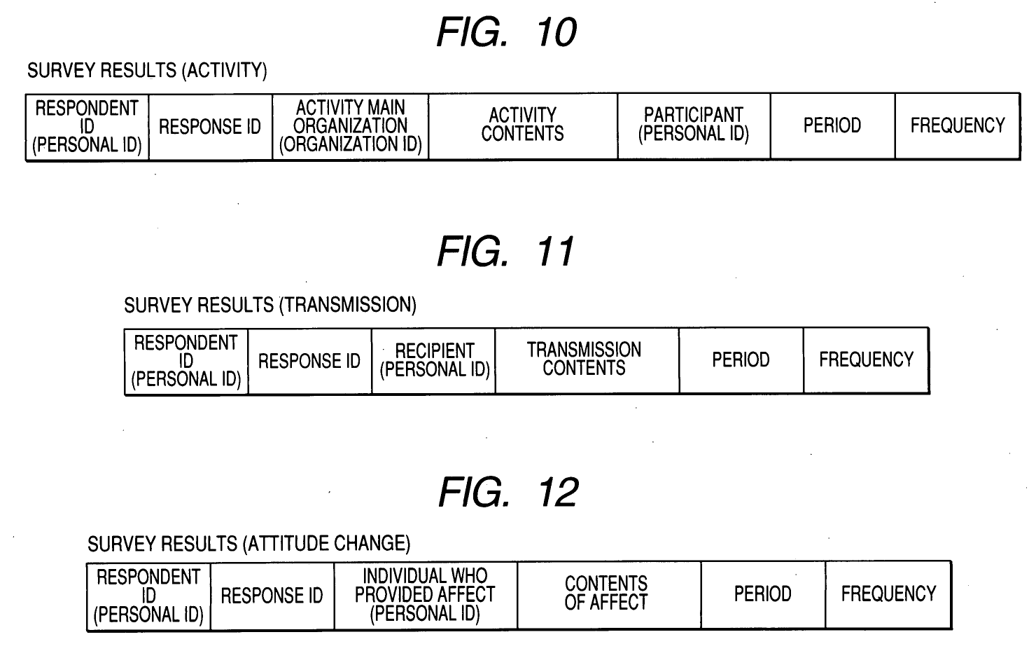

FIG. 10 is a diagram showing example survey result information for activities that the survey unit 342 stores in the survey result DB 344.

FIG. 11 is a diagram showing example survey result information for data propagation that the survey unit 342 stores in the survey result DB 344.

FIG. 12 is a diagram showing example survey result information for psychological activities that the survey unit 342 stores in the survey result DB 344.

The survey unit 342, which has the same functions as the web server 266 of the server program 26 (FIG. 4), displays questions for the organizational communication survey using the web browsers 226 operated by the client computers 20-1 to 20-m, and presents the questions to the members of the organization system 2.

When the members of the organization systems 2 propagate the answers to the displayed questions through the web browsers 224 operated by the client computers 20, the survey unit 342 (FIG. 5) aggregates the answers, prepares the survey result information shown in FIGS. 10 to 12, in accordance with the contents of the answers and questions, and stores the information in the survey result DB 344.

For example, when the questionnaire survey is conducted to determine how the information for the organizations obtained through the mailing list is utilized for personal activities, the survey unit 342 issues, to the member of the organization systems 2, the question, “Has the exsistance of the mailing list (ML) and the discussion topics of the mailing list been useful, in any way, in your work or activity?”.

In correlation with the answers received, for the question, that are from the members with the personal information and the organization information (FIGS. 6 through 9) that are stored in the organization and member DB 350, the survey unit 342 prepares the survey result information, using the form shown in FIG. 10, that includes: the identifiers (respondent IDs; personal IDs) used to identify respondents; identifiers (response IDs that will be described later) used to identify the answers; identifiers (organization IDs) used to represent organizations that include a member that participated in specific activity; the contents of activities; the identifiers (personal IDs) representing members involved in activities; and activity periods and frequencies. The survey result information is stored in the survey result DB 344.

Furthermore, when the questionnaire survey is conducted to determine how the information for the organizations obtained from the mailing list was propagated, the survey unit 342 issues, to the members of the organization systems 2, the question, “Have you told people around you of the exsistance of the mailing list and of the discussion topics of the mail list?

By correlating the answers to the question received from the members with the personal information and the organization information (FIGS. 6 through 9) stored in the organization and member DB 350, the survey unit 342 assembles the survey result information required for preparing the form shown in FIG. 11, which includes: respondent IDs (personal IDs), response IDs, recipient IDs (personal IDs), representing the recipients of information, the contents of the information that was propagated (propagation contents), and the information propagation time and the frequencies used. These entries for the obtained survey result information are stored in the survey result DB 344.

Further, when the survey by questionnaires is conducted to assess changes in the attitudes of the member organization members, for example, the survey unit 342 issues, to the members of the organization systems 2, the question, “Has the exsistance in the mailing list of the topics discussed using the mailing list changed your attitude and your thoughts?”.

By correlating the answers to the question received from the members with the personal information and the organization information stored in the organization and member DB 350, the survey unit 342 assembles the survey result information used to prepare the form shown in FIG. 12, which includes: the respondent IDs (personal IDs), the response IDs, the identifiers (personal IDs) of the members that have psychologically influenced the respondents, the contents of the psychological influences, and the periods and the frequencies whereat the psychological influences were provided. This survey result information is stored in the survey result DB 344.

It should be noted that instead of permitting the respondents to directly provide information indicating a member whom psychologically influenced the respondent, the survey unit 342 may perform a text analysis of the sentences included in the answers given by the respondents and automatically obtain the desired information.

In the examples shown in FIGS. 10 through 12, the personal IDs or the organization IDs are used to assemble the survey result information, and the personal IDs can be converted into organization IDs using the information stored in the organization and member DB 350 in FIGS. 6 through 9.

Therefore, survey results that represent the effect that a specific person has on other persons, for example, can also be changed into survey results that represent the effect a specific organization has had on members and other organizations.

In addition to the survey explained while referring to FIGS. 10 through 12, the survey unit 342 can conduct a survey by questionnaires to examine the personal attributes of respondents, the attributes of the organizations of the respondents, the external environments of the respondents, and the personal cognition of the respondents.

When a survey by questionnaires is conducted for the external environments of the respondents, the survey unit 342 issues, to the members of the organization systems 2, the questions, “How much space is available in your office for unofficial discussion?” and “Do you think your office is so located information can be easily exchanged with another relevant organization?”.

When a survey by questionnaires is conducted to ascertain the personal cognition of the respondents, the survey unit 342 issues questions to the members of the organization systems 2 concerning the qualities of the organizations that employ and utilize the common information, including, “Does the work atmosphere in your department make it easy to help each other with a problem?” and “Does your department have specific systems for evaluating the use of common information and for evaluating your personal results?”.

For one survey by questionnaires, dependent on the number of answers permitted for each question, the number of information sets is determined when assembling the survey result information shown in FIGS. 10 through 12, and sets are prepared for each of the respondent members in the organization systems 2 that provided answers.

For example, when up to three answers are permitted for a question included in a specific survey, one to three sets of survey result information are prepared for each respondent (respondent ID).

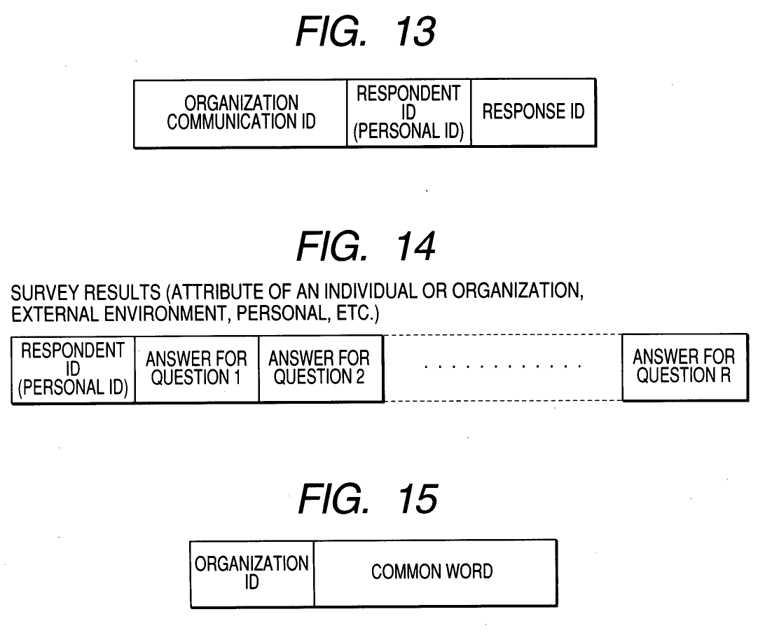

FIG. 13 is a diagram showing an organizational communication ID defined for the response result information shown in FIGS. 10 through 12.

When a plurality of information sets of survey results are to be prepared for one respondent, the survey unit 342 adds unique response IDs to the survey result information sets (FIGS. 10 through 12) having the same response ID, so that these information sets can be managed separately.

Further, as is shown in FIG. 13, the survey unit 342 uniquely defines the organizational communication ID for each respondent ID and the response ID combination described above, and employs the organizational communication ID to manage the survey result information shown in FIGS. 10 through 12.

FIG. 14 is a diagram showing the correspondence of the survey result information in FIGS. 10 through 12 with a respondent.

When a plurality of sets of survey result information (FIGS. 10 through 12) are prepared for one respondent who has provided answers for a plurality of questions, the survey unit 342, as is shown in FIG. 14, correlates the respondent ID with the identifiers (e.g., the response IDs) representing the member questions, and manages, for each respondent, the answers to a plurality of questions.

[Analysis and Evaluation Unit 346]

An explanation will now be given for the analysis processing and the evaluation processing performed by the analysis and evaluation unit 346.

[Analysis of Common Words]

The analysis and evaluation unit 346 employs the organization and member DB 350, and sorts into the organizations to which the respondents belong the corresponding respondent IDs in the survey result information (FIGS. 10 through 12) that is stored in the survey result DB 344.

Further, the analysis and evaluation unit 346 extracts a common word that is included in the specific and substantial contents (contents information) of the activities, information propagation and psychological influences that are included in the survey results information obtained, as the result of the sorting, for the organizations.

FIG. 15 is a first diagram showing example information that the analysis and evaluation unit 346 in FIG. 5 stores in the analysis and evaluation result DB 348 for a word common to an organization.

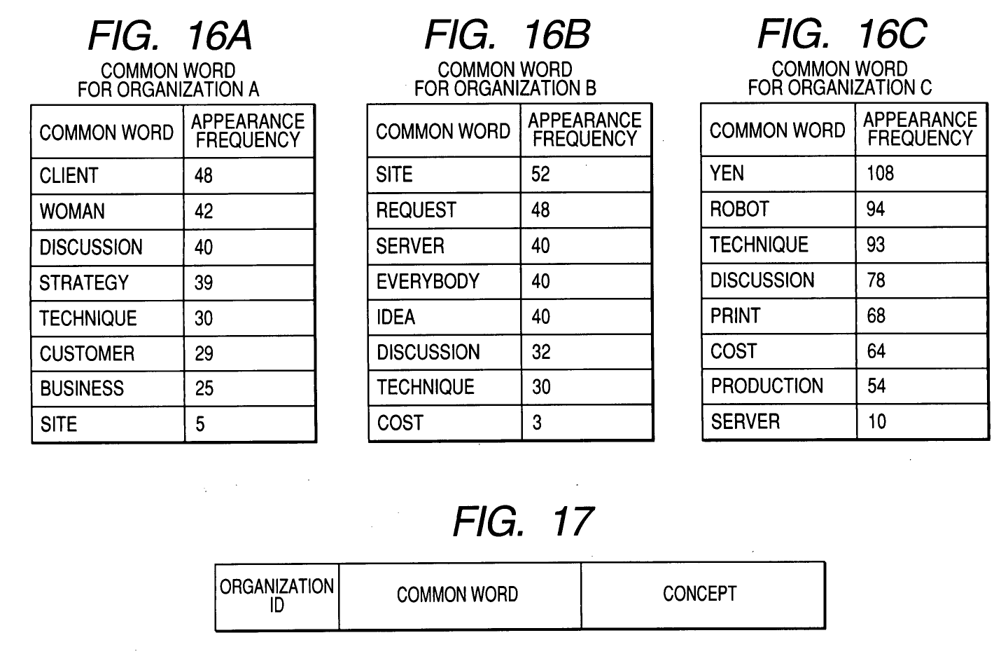

FIGS. 16A through 16C are diagrams showing specific example common word information presented in FIG. 15.

The analysis and evaluation unit 346 selects words that frequently appear in the content information that is included in the survey result information provided by a respondent, a member of an organization P, e.g., selects three words, x, y and z, in the descending order, beginning with the highest frequency. Then, as is shown in FIG. 15, the analysis and evaluation unit 346 adds the organization ID (FIGS. 6 and 7) of organization P to the words x, y and z, and prepares intra-organizational common word information (an attribute). This information is then stored in the analysis and evaluation result DB 348.

As is shown in FIGS. 16A through 16C, the common word information is entered in a list in correlation with the organization ID.

FIG. 17 is a second diagram showing an example concept common to an organization, which the analysis and evaluation unit 346 in FIG. 5 stores in the analysis and evaluation result DB 348.

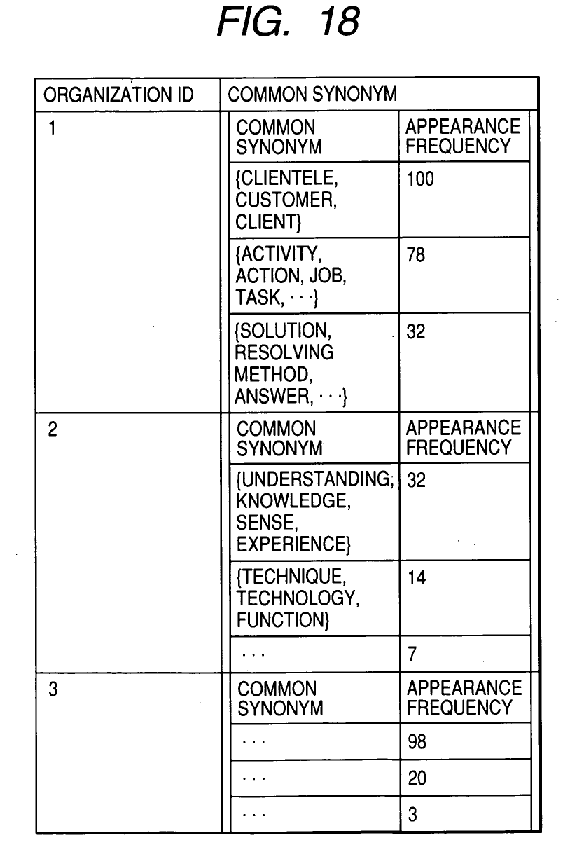

FIG. 18 is a diagram showing a specific example for a common concept in FIG. 17.

As is described above, the analysis and evaluation unit 346 extracts information representing another concept for a common word, such as a sentence included in the contents of the intra-organizational communication information, synonyms for the common word, a semantic network for the common word and the synonyms, and an ontology (a set of common concepts that is used in the organization P).

As is shown in FIG. 15, the analysis and evaluation unit 346 records the extracted words independently.

Or, as is shown in FIG. 17, the analysis and evaluation unit 346 may store the extracted words in correlation with other concepts for the words, e.g., the common word information (FIGS. 15, 16A, 16B and 16C).

Shown in FIG. 18 is a specific example wherein the common synonym is recorded independently as the common concept. The common synonyms can be extracted and aggregated when the analysis and evaluation unit 346 employs an ordinary thesaurus, to obtain a set of words having the same meaning, and performs the same processing that performed to extract the common word for the organizational communication information.

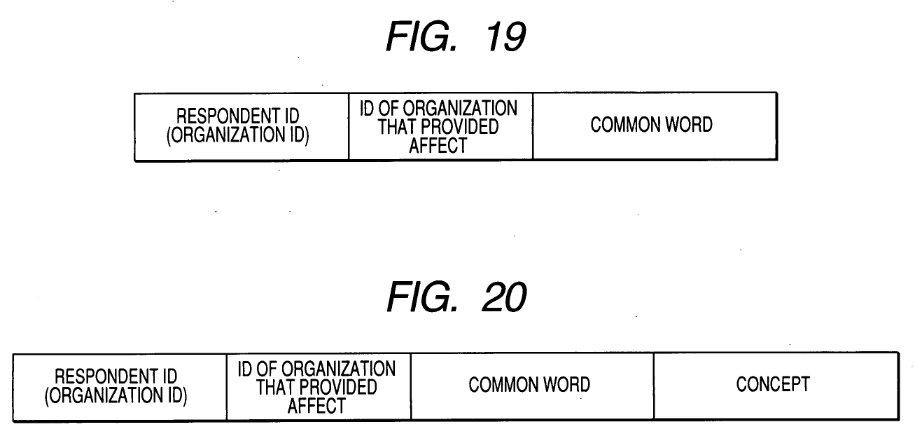

FIGS. 19 and 20 are first and second diagrams showing example intra-organizational common word information, including a concept that the analysis and evaluation unit 346 in FIG. 5 stores in the analysis and evaluation result DB 348.

Further, the analysis and evaluation unit 346 examines the organization and member DB 350 to identify, for each set of the survey results information (FIGS. 10 through 12), the organizations of the respondent and a partner (e.g., the member whom participated the activity, the person concerned and the information recipient, or the person who influenced the respondent).

Furthermore, the analysis and evaluation unit 346 extracts the common word and the concept from the content information included in the survey results indicating that the respondent and the person who influenced the respondent belong to different organizations P and Q (P≠Q).

As is shown in FIG. 19 or 20, the analysis and evaluation unit 346 prepares the inter-organization common word information by adding to the extracted common word and the concept the identifier (a personal ID or a organization ID) for the respondent or the organization to which the respondent belongs, and the identifier (an organization ID) for the organization to which the person who influenced the respondent belongs. This inter-organization common word information is stored in the analysis and evaluation result DB 348.

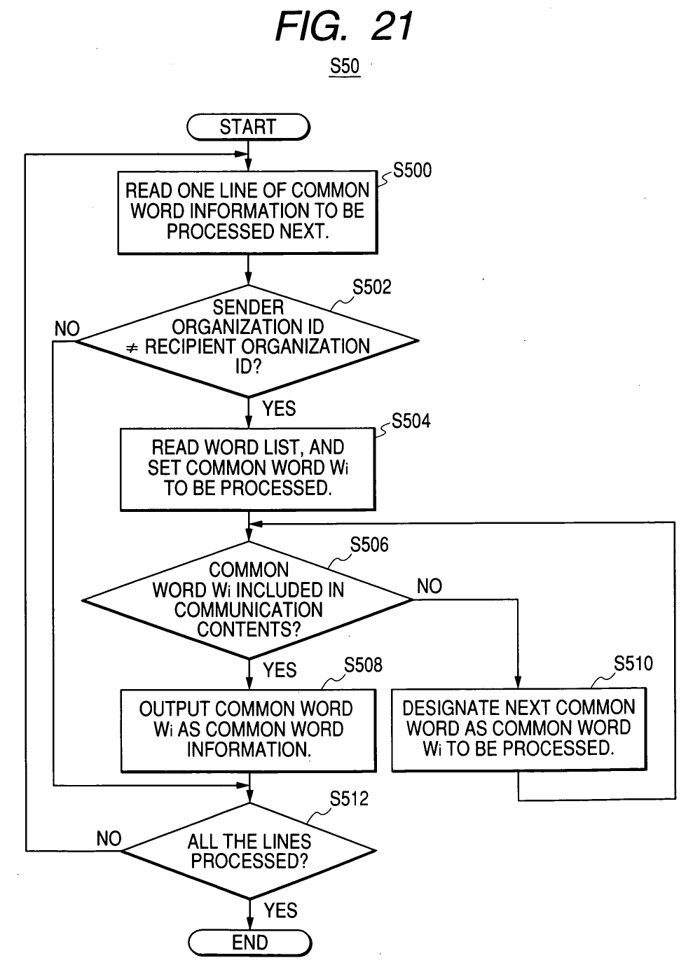

FIG. 21 is a flowchart showing the matching processing (S50) performed by the analysis and evaluation unit 346 for extracting a common concept for the survey results information (FIGS. 10 through 12).

By employing a specific example wherein a word is obtained as a common concept from emails that have been exchanged and that have originated at two different organizations, an explanation will now be given for the processing whereby the analysis and evaluation unit 346 extracts a common concept for the survey results information (FIGS. 10 through 12).

At step 500 (S500), the analysis and evaluation unit 346 employs, as a processing unit, each line of the survey result information (FIGS. 10 through 12), beginning with the first line. Of the lines of the survey result information that have not yet been processed, the first line is read as a processing target line.

At step 502 (S502), the analysis and evaluation unit 346 determines whether the ID (the sender organization ID) of the organization to which the respondent belongs, and which is included in the survey result information to be processed, differs from the ID (the recipient organization ID) of the organization that, according to the response, was influenced by the respondent.

When the analysis and evaluation unit 346 has determined that the ID (the sender organization ID) of the organization of the respondent differs from the ID (the recipient organization ID) of the organization that was influenced, program control advances to step S504. In the other case, program control is shifted to step S512.

That is, when the ID (the sender organization ID) of the organization to which the respondent belongs differs from the ID (the recipient organization ID) of the organization that was influenced by the respondent, and when the word (the common concept) of the sender organization is shared by the recipient organization and the sender organization, it is assumed that the organization (the sender organization) of the respondent performed communication with (provided influence content for) the organization (the recipient organization) that was influenced.

At step 504 (S504), the analysis and evaluation unit 346 reads a common word list for the ID (the sender organization ID (recipient organization ID)) of the influenced organization, which is included in the survey result information to be processed. Then, the analysis and evaluation unit 346 designates a common word Wᵢ to be used for the matching processing.

At step 506 (S506), the analysis and evaluation unit 346 determines whether the common word Wᵢ to be processed is included in the communication contents included in the line of the survey results information to be processed.

When the analysis and evaluation unit 346 determines that the common word Wᵢ to be processed is included in the line of the survey results information to be processed, program control advances to step 508. In the other case, program control is shifted to step 510.

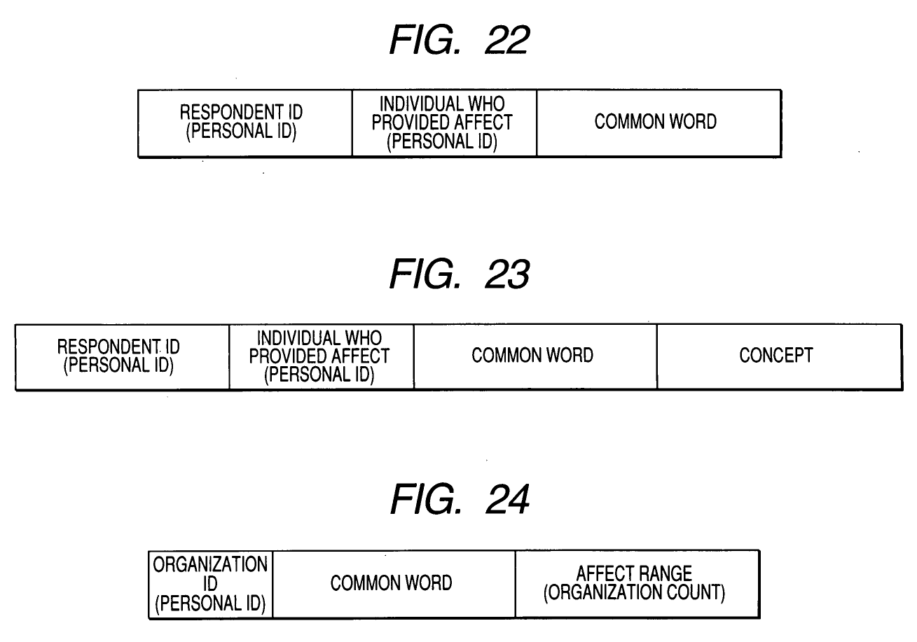

At step 508 (S508), the analysis and evaluation unit 346 stores, as inter-organization information shown in FIG. 22, the common word Wᵢ to be processed.

At step 510 (S510), the analysis and evaluation unit 346 designates, as the next common word Wᵢ to be processed, a common word Wᵢ₊₁ that is included in the word list and that as yet has not been processed.

At step 512 (S512), the analysis and evaluation unit 346 determines whether all the lines in the survey result information have been processed.

When the analysis and evaluation unit 346 ascertains that all the lines have been processed, the processing is terminated. In the other case, program control returns to step 500.

To summarize the matching processing in FIG. 21, first, the analysis and evaluation unit 346 reads each line of the survey result information, extracts the pertinent communication contents, and performs a matching process for the common word for the organization (the sender organization ID) to which the respondent belongs, and the communication contents included in the line that has been read.

This matching processing is performed when the ID (the sender organization. ID) of the organization to which the respondent belongs, and which is included in the survey results information to be processed, differs from the ID (the recipient organization ID) that has been influenced.

As a result of the matching processing, when the common word for the ID (the sender organization ID) of the organization to which the respondent belongs is included in the communication contents, it is assumed that the intra-organizational information exchanged in the organization (the sender organization) of the respondent has influenced the recipient organization. This common word is then stored as the common word information shown in FIGS. 19 and 20.

The matching processing is performed for all the common words included on common word lists that are correlated with the IDs (sender organization IDs) of the organizations that are included in the line of the survey result information to be processed and that the respondents belong.

When the matching processing has been performed for all the survey result information, the common word information (FIG. 19) is prepared that indicates the degree of influenceion, i.e., which organization influences which organization through which common word.

When the same processing shown in FIG. 21 is performed for the concept (a sentence, a synonym for the common word, the semantic network using the common word, and the synonym and the ontology), instead of the common word, the common word information (FIG. 20) is prepared that indicates which of the two organizations has provided what kind of content that has influenced the other.

Furthermore, when the extraction and aggregation processing for the common concept (the word) and the matching processing shown in FIG. 21 are performed for the survey result information that is exchanged by two or more organizations, it is possible to understand which organization has influenced which other organization through which common word.

For example, assume that the organization (the sender organization) P of the respondent has propagated information to the organizations (recipient organizations) Q and R that were influenced. In this case, the ID (the sender organization ID) of the organization to which the respondent belongs is used as the organization ID for the organization P; the ID (the recipient organization ID) of the organization that was influenced is used as the organization ID of the organization Q; and the organization ID of the recipient is used as the organization ID of the organization R. When the common word extraction processing and the matching processing in FIG. 21 are performed for these IDs, the common word information can be obtained.

FIGS. 22 and 23 are first and second diagrams showing example common word information that the analysis and evaluation unit 346 in FIG. 5 stores in the analysis and evaluation result DB 348 for a member.

Further, as is shown in FIGS. 22 and 23, the analysis and evaluation unit 346 prepares member-based common word information by adding, to the extracted common word and the concept, the identifier (the personal ID or the organization ID) of the respondent or of the organization to which the respondent belongs, and the identifier (the personal ID) of the person who has influenced the respondent. The member-based common word information is stored in the analysis and evaluation result DB 348.

[Evaluation of Influences Provided by Organizations and Members]

By employing the thus generated intra-organizational common word information (e.g., FIG. 15) and the member-based common word information (FIGS. 22 and 23), the analysis and evaluation unit 346 can compare the intra-organizational communication information for the organization P to be evaluated, or the member-based common information indicating the “i”th member has provided influence content, with the intra-organizational common information (e.g., FIG. 15) for the organizations Q (Q=1 ton; Q≠P), and the inter-organization common word (FIGS. 19 and 20).

Furthermore, the analysis and evaluation unit 346 determines to be an organization that was influenced by the target organization, or a member to be evaluated, an organization, or a member, for which the intra-organizational or intra-member common word information includes, as a common word or a concept, the common word or concept (FIG. 15) extracted for the target organization, or the member, and indicates that the target organization, or the member, is the organization, or the member, that is the source of the influence.

When the evaluation of an influence provided by an organization, or a member, is performed for all organizations, and all members, which organization, or which member, has provided content that influences which organization, or which member, can be sequentially traced. As a result of this tracing, any influence that an organization, or a member, has had on another organization can also be serially evaluated.

For this chained evaluation, the survey unit 342 may perform weighting based on the number of chains.

Assume that a series of serially performed communications, in which a common word WX is included, proceed from an organization A to an organization B, from the organization B to an organization D, and from the organization D to an organization E. In order to evaluate the strength of influence for the organization A, the survey unit 342 may add a value “1” to the number of organizations as the strength of influence provided for the organization B, may add a value “½” to the organization count as the strength of influence for the organization D through the organization B, and may add a value “¼” to the organization count as the strength of influence for the organization E through the organizations B and D.

The definition of the extent of influence is the number of respondents that are influenced by “organization β” while a respondent A in organization a “propagated information X to organization β”. The respondent A is not included in this count, and the respondents are counted without any being overlapped.

That is, the questionnaire can also be issued serially, not only to the members of the organization α to be surveyed, but also to the members of the organization β. This survey method is also called snowball sampling, according to the technical term for the social survey.

In this case, a threshold value can be determined for the chained survey by using snow ball sampling.

Further, to avoid the circulation of the chain transfer, an appropriate restriction must be established.

In addition, the question in the questionnaire that is serially distributed should be customized as, “Where did you propagate information X that was returned by the respondent A of the organization α?”, and only this question must be serially distributed.

The evaluation values for the extent of influence may be aggregated for each concept ID, and the extent of influences for all the concept IDs may be aggregated to obtain the extent of influence for the organization A.

When the information provided by the organization A has been used for the activities of the organization A and the other organizations, the number of organizations that have used the information is regarded as the extent of influence.

An aggregation and an evaluation are not performed for the information that has provided a psychological change.

FIGS. 24 and 29 are first and second diagrams showing example evaluation values that the analysis and evaluation unit 346 in FIG. 5 stores in the analysis and evaluation result DB 348.

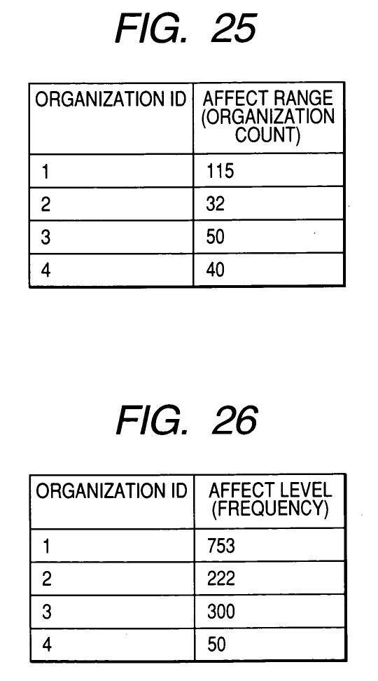

FIG. 25 is a diagram showing a specific example for the extent of influence in FIG. 24.

FIG. 26 is a diagram showing a specific example for the strength of influence.

The analysis and evaluation unit 346 employs, as an evaluation index that represents the level of the influence provided by an organization or a member to be evaluated, the number of organizations obtained as the determination result.

When a questionnaire for the evaluation of five steps is distributed, the member choices are weighted by values 4, 3, 2, 1 or 0, and the obtained values are added together. Then, instead of simply the number of organizations that have provided an influence, this obtained sum may be used as the evaluation index for the organization or member to be evaluated.

The processing for evaluating the common word information in FIGS. 22 and 23 will now be described.

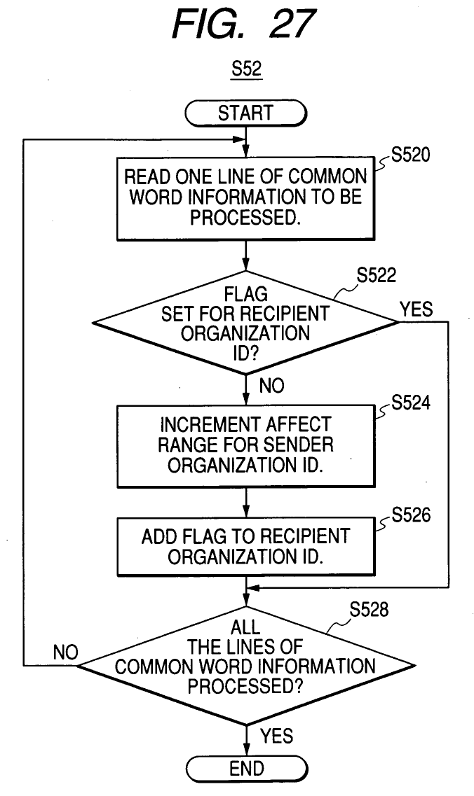

FIG. 27 is a flowchart showing the processing (S52) for calculating the extent of influence in FIG. 24.

As is shown in FIG. 27, at step 520 (S520), the analysis and evaluation unit 346 processes the common word information (FIGS. 22 and 23) for each line, starting at the beginning. That is, of the lines of the common word information that have not yet been processed, the first line is read for processing.

At step 522 (S522), the analysis and evaluation unit 346 determines whether a flag has been set for the ID (recipient organization ID) of an organization that was included in the line of the common word information read at S520 and that was influenced.

When the flag has been set for the ID (recipient organization ID) of the organization that was influenced, the analysis and evaluation unit 346 advances to the process at S528. In the other case, the analysis and evaluation unit 346 shifts to the process at S524.

At step 524 (S524), the analysis and evaluation unit 346 increments the value of the extent of influence for the ID (sender organization ID) of the organization to which the respondent belongs.

At step 526 (S526), the analysis and evaluation unit 346 adds a flag to the ID (recipient organization ID) of the organization that was influenced.

At step 528 (S528), the analysis and evaluation unit 346 determines whether all the lines of the common word information have been processed.

When all the lines of the common word information have been processed, the analysis and evaluation unit 346 terminates the processing. In the other case, the analysis and evaluation unit 346 returns to the process at S520.

The processing in FIG. 27 can be summarized as follows.

First, the analysis and evaluation unit 346 reads each line of the common word information (FIGS. 22 and 23).

Then, based on the common word information, the analysis and evaluation unit 346 counts the organizations (recipient organizations) that were influenced.

In order to count, without any overlapping, the organizations (recipient organizations) that were influenced, the analysis and evaluation unit 346 adds a flag to the IDs of the recipient organizations that have been counted, so that the analysis and evaluation unit 346 will skip the influenced organizations (recipient organizations) for which a flag has been provided.

The analysis and evaluation unit 346 performs this counting for all the lines of the common word information, and defines the obtained value as the range within which a specific organization (the organization that has provided the influence content or the sender organization) has influenced all the organizations.

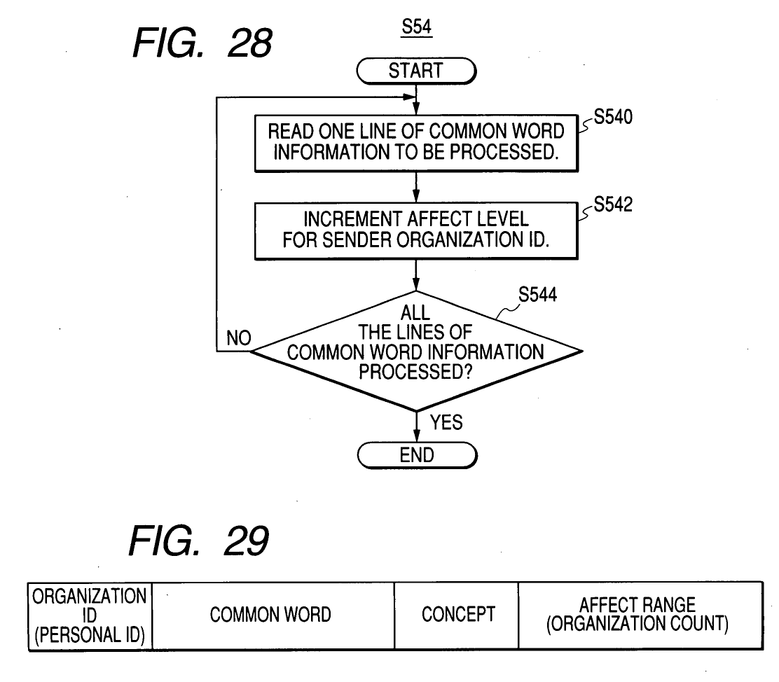

FIG. 28 is a flowchart showing the processing (S54) in FIG. 27 for calculating the strength of influence.

As is shown in FIG. 28, at step 540 (S540), the analysis and evaluation unit 346, for example, processes the common word information (FIGS. 22 and 23) for each line, starting at the beginning. That is, of the lines of the common word information that have not yet been processed, the analysis and evaluation unit 346 reads the first line for processing.

At step 542 (S542), the analysis and evaluation unit 346 increments the level for an organization (the propagation side) that provided the influence content.

At step 544 (S544), the analysis and evaluation unit 346 determines whether all the lines of the common word information have been processed.

When all the lines of the common word information have been processed, the analysis and evaluation unit 346 terminates the processing. In the other case, the analysis and evaluation unit 346 returns to the process at S540. The processing shown in FIG. 28 can be summarized as follows.

The analysis and evaluation unit 346 reads each line of the common word information (FIGS. 22 and 23), and finds, for each sender organization, a cumulative sum of number of times that a specific common word was used by the organization that was influenced (the recipient organization).

The analysis and evaluation unit 346 performs this aggregation for all the lines of the common word information, and defines the obtained value as the level at which a specific organization (the organization that provided the influence content; sender organization) has influenced all the organizations.

It should be noted that the analysis and evaluation unit 346 may find the total value of the frequencies at which the common word appeared in the organization that provided the influence content (the sender organization). In this case, when a common word used more frequently by a specific organization is used by another organization, to calculate the strength of influence for all the other organizations, the analysis and evaluation unit 346 may return a high estimate as the strength of influence for the specific organization.

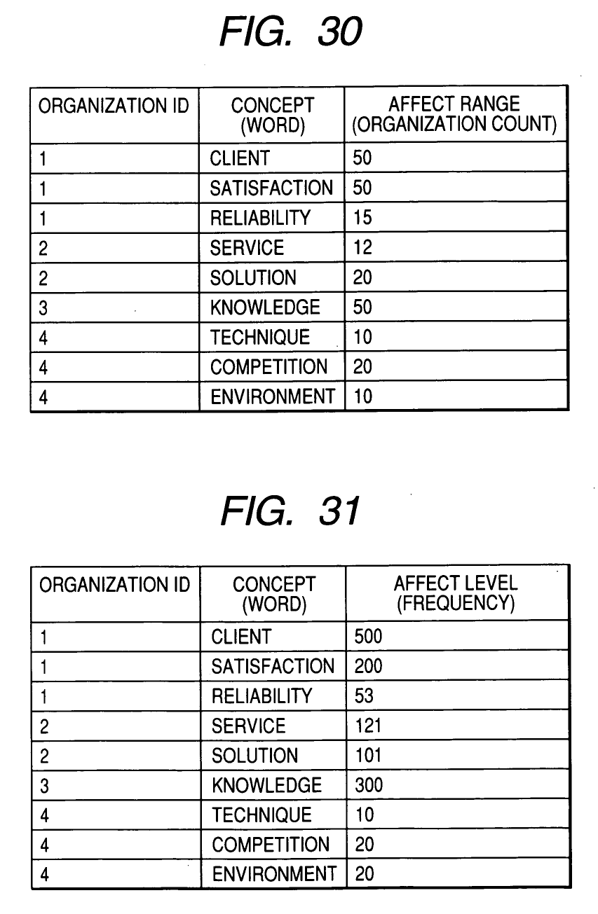

FIG. 30 is a diagram showing example extent of influences obtained for the member concepts.

FIG. 31 is a diagram showing example strength of influences obtained for the member concepts.

As is shown in FIGS. 24 to 29, as the number of influenced organizations and the extent of influence, the analysis and evaluation unit 346 adds the common word and the concept to the identifiers (the organization ID and the personal ID) for the organization and the member to be evaluated, and stores this information in the analysis and evaluation result DB 348.

The processing performed by the analysis and evaluation unit 346, to obtain the extent of influence and the strength of influence for each organization, may be changed to the processing performed to obtain the extent of influence and the strength of influence for each concept shown in FIGS. 30 and 31.

It should be noted that when analyzing the appearance frequency for a common word X, instead of the overall network system (company) 1, only the organization Q of an employee J who communicates with an employee I of the organization P may be focused on.

When in addition to the organization P, the same word is used by the organization Q merely by coincidence, it is wrong to determine that the organization Q has been influenced by the organization P. And when the above described process is performed, an influence for which it is determined the influence attribution was erroneous can be removed from the influencing actions by which a specific organization has influenced another organization.

Furthermore, when between the organization P and the organization Q there is no direct communication, but instead, the organizations communicate with each other indirectly, through another organization S, the chained transfer of influencing acts is evaluated, and the total of the evaluation values can be used by the organization P to influence the organization Q.

Assume that the organizations A to D employ the word X for intra-organizational and inter-organizational communications, and that the organizations A, B and D use the common word X when communicating, while the organization C does not use the word X when communicating with any other organization. In this case, the appearance of the common word X in the organization C does not count when calculating the strength of influence that the organization A provides for the organization C.

[Evaluation of Common Word and Concept]

As is shown in FIGS. 24 through 29, the analysis and evaluation unit 346 evaluates not only how a member or organization to be evaluated has influenced other members or organizations, but also how an extracted common word, as is shown in FIG. 15, and the concept of the word (the concept includes a word, a sentence, a semantic network and the ontology, and a word is merely an example) have influenced the members and organizations.

That is, the analysis and evaluation unit 346 extracts an organization or a member that corresponds to the common word information shown in FIG. 15 (intra-organizational common word information, inter-organization common word information or member-based common word information), for example, that includes the common word and the concept extracted for a member or organization to be evaluated. Thus, the analysis and evaluation unit 346 can determine how the organization or the member to be evaluated will be influenced by the common word and the concept that are extracted for the evaluation.

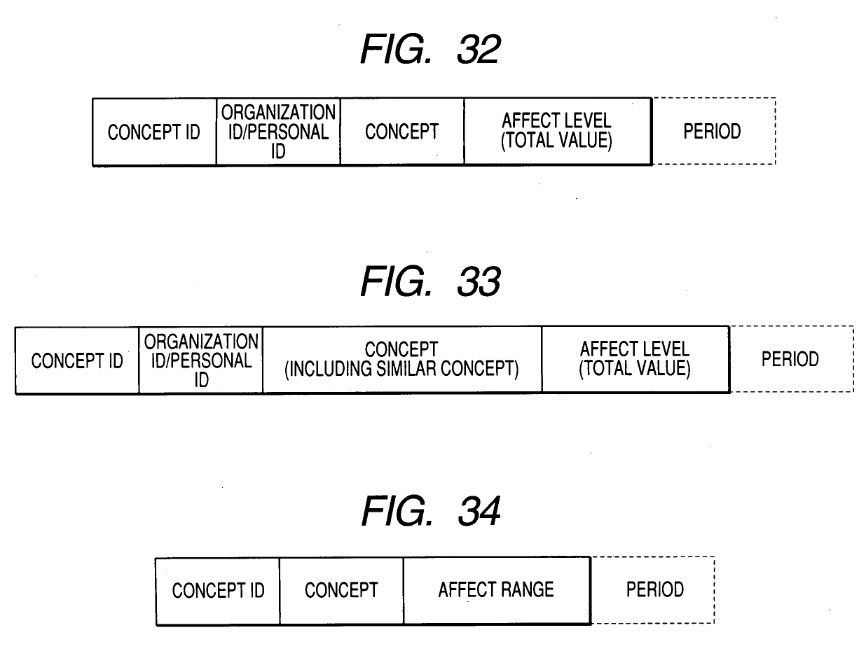

FIGS. 32 through 34 are first to third diagrams showing example evaluation results of how the concept influences the organization or the member.

Specifically, the analysis and evaluation unit 346 compares, with a concept to be evaluated (FIG. 17, 20 and 23), the common word information that is extracted for a member or organization to be evaluated, and extracts the common word information in FIG. 15, for example, that includes the concept extracted for the member or organization to be evaluated. Then, the analysis and evaluation unit 346 determines that an organization or member that corresponds to the extracted common word information was the one influenced by the concept to be evaluated.

The analysis and evaluation unit 346 adds, to each concept, an identifier (concept ID) and the identifier (organization ID or personal ID) of the organization or the member that corresponds to this concept. Further, the analysis and evaluation unit 346 adds, as the strength of influence, the number of organizations and members that are determined to have been influenced, and stores, in to the analysis and evaluation result DB 348, the resultant information in a form shown in FIG. 32.

The analysis and evaluation unit 346 may include an additional function whereby, by employing a conventional method, the difference in the identity of the concept to be evaluated and another concept is evaluated as a numerical value, and the concept that obtains a predetermined numerical evaluation value or higher is extracted as a concept similar to the concept to be evaluated. In this case, the analysis and evaluation unit 346 determines, as is shown in FIG. 33, that an organization or member that corresponds to the common word information that includes both the concept to be evaluated and the similar concept is the one influenced by the organization or member to be evaluated.

Further, apart from an organization or member, the analysis and evaluation unit 346 may employ the concept itself as an evaluation target, and may determine that, as is shown in FIG. 34, an organization or member that corresponds to the common word information, including the concept to be evaluated, falls within the range of the organizations and members that have been influenced by the concept to be evaluated. These determination results are stored in the analysis and evaluation result DB 348.

In addition, the analysis and evaluation unit 346 may obtain, for each organization or member, the total value for the strength of influences of the common word and the concept shown in FIGS. 32 through 34, and may employ the total value to determine the strength of influence for each organization or member.

[Statistical Analysis]

The analysis and evaluation unit 346 employs a general method, such as a simple correlation analysis, a regression analysis, a main component analysis or a factor analysis, to perform the statistical processing for the information (e.g., in FIG. 15) stored in the analysis and evaluation result DB 348, analyzes the correspondence of the information, and stores the obtained result in the analysis and evaluation result DB 348.

Through this statistical processing, relationships are clarified within an organization to which a respondent belongs, other organizations and members that are influenced by this organization, the attributes of these organizations and members, and the information by which the organizations and the member are influenced.

While this statistical analysis is not for the evaluation of the value of an organization or a member, this analysis is effective means for understanding which organization or member influenced which respondents, either the respondents that utilized the information, the respondents that propagated the information, or the respondents that were psychologically changed due to the information, and to understand whether the value of the organization or member has been increased.

The understanding of the relationships provided by the statistical analysis, for example, is used as a guideline for creating an organization that can produce a high value, or as an important reference material for the management required for improving an organization or member that is used to produce only a low value for an organization or am member that produces a high value.

Assume that the results obtained by the statistical analysis show that respondents that propagate valuable information are highly correlated with and have an understanding of the organization of the respondents so that it is their understanding that “the work atmosphere in your department makes it easy to help each other with a problem”, and that “your department has specific systems for evaluating the use of common information and for evaluating your personal results”. In this case, it is understood that, for an organization to produce a high value, the objective of the development of the atmosphere in the organization must be that it can “make the members help each other with problems”, and this knowledge can be effectively used for the management of a company.

[Time Series Analysis]

Since the survey result information (FIGS. 10 and 11) includes information representing periods propagation when an activity, propagation, and pshological influence happens, the analysis and evaluation unit 346 can add to the evaluation result information, as needed, information for the periods for the survey results information to be evaluated, as indicated by broken lines in FIGS. 32 through 34.

When the period information is included in the survey result information, the analysis and evaluation unit 346 can analyze the evaluation result information in a time series manner, and can store the analysis results in the analysis and evaluation result DB 348.

Similarly, using a time series analysis, the analysis and evaluation unit 346 can determine how the evaluation results have been changed as time elapsed, e.g., how a specific concept has spread to all the organizations in the company, and stores the analysis result in the analysis and evaluation result DB 348.

Furthermore, the analysis and evaluation unit 346 focuses on a specific organization A, and analyzes how the value of the organization A and the value of the concept used by the organization A have been changed, and stores the analysis results in the analysis and evaluation result DB 348.

The evaluation results obtained by the analysis and evaluation unit 346 for the member organizations and members can be displayed in various forms by the UI unit 352.

[Comprehensive Evaluation]

The results obtained through the time series analysis are displayed as a sequential line graph, for example, on the display and input device 206 (FIG. 2).

In addition, in consonance with user manipulation, the analysis and evaluation unit 346 displays, by ranks, the levels at which a specific organization can influence other organizations, or receives information for distances between organizations and displays the correspondence of the strength of influences with the distances separating the organizations.

The analysis and evaluation unit 346 evaluates not only each organization and each member, but also adds evaluation values for a plurality of organizations and members to provide a comprehensive evaluation for these organizations and members.

Specifically, in addition to independently evaluating organizations A through F and displaying or outputting the evaluation results, the analysis and evaluation unit 346 adds the evaluation values for the organizations A through D and adds to them the evaluation values for the organizations E and F, and stores, in the analysis and evaluation result DB 348, the comprehensive evaluation value for the organizations A through D and the comprehensive evaluation value for the organizations E and F, or uses the UI unit 352 display these values for a user.

Further, through a comparison between the evaluation information for the two organizations A and B, for example, the analysis and evaluation unit 346 performs a cross-sectional analysis of the difference in the intra-organizational communication between the organizations A and B, a difference in the extent of influence and a difference in the time-transient change of the value between the organizations A and B. The obtained results are stored in the analysis and evaluation result DB 348.

[Overall Operation of Network System 1]

The overall operation of the network system 1 will now be explained.

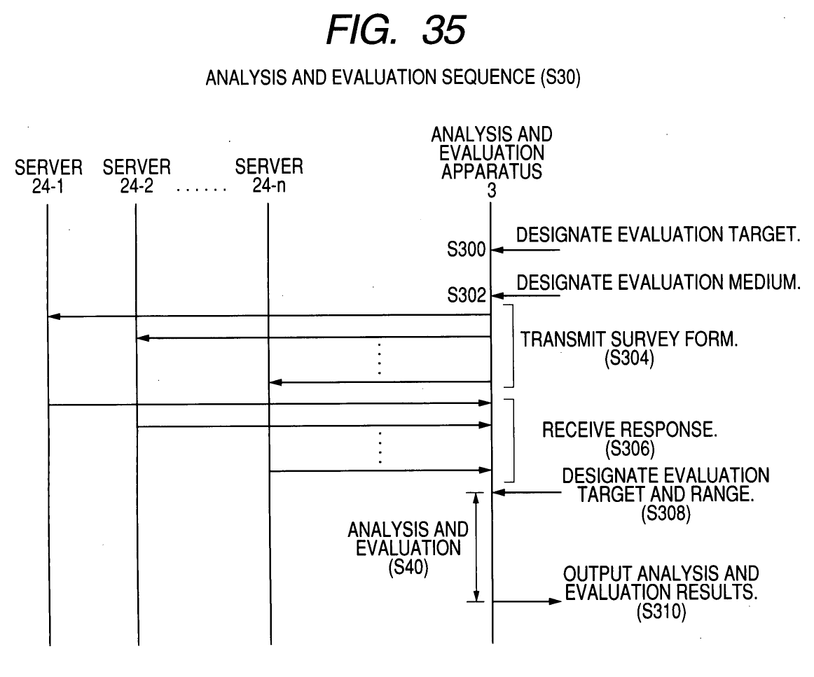

FIG. 35 is a diagram showing the analysis and evaluation sequence (S30) performed by the network system 1.

As is shown in FIG. 35, a user manipulates the display and input device 206 (FIGS. 1 and 2) of the analysis and evaluation apparatus 3 to select, as the organization P (organization system 2-P) or the member I to be evaluated, one of the organizations of the first through the “n”th organizations (organization systems 2-1 to 2-n) and the members of the first through the “m”th members, to select the WWW or email as one medium for performing the survey by questionnaires, and to designate the questions used in the questionnaire for the survey (S300 and S302).

For example, the user of the analysis and evaluation apparatus 3 can designate how an organization z communications, concerning a project X, have influenced the company.

Further, in addition to the influence on the overall company organization, the user can also designate a range for analyzing the influence that the organization Z communications, concerning the project X, have had on a plurality of organizations or a group of employees in the company.

In this embodiment, as previously described, the WWW is designated by the user as an example medium.

In accordance with the selection and designation performed by the user, the UI unit 352 of the analysis and evaluation program 34 (FIG. 5) controls the survey unit 342, and displays, on web pages provided by the web server 266 (FIG. 4) of the server 24 (FIG. 1) that is referred to by each of the members of the organizations (organization systems 2-1 to 2-n), an image (survey form) to present questions for the questionnaire survey and to accept answers (S304).

When the user enters answers for the questions using the survey form on the web page, the web browser 224 (FIG. 3) operated by each of the client computer 20 (FIG. 1) sequentially propagates, to the survey unit 342 (FIG. 5), a response in which the contents of the answers are indicated. These responses are received by the survey unit 342 operated by the analysis and evaluation apparatus 3 (S306).

The user designates the evaluation range (S308).

Specifically, the user employs the display and input device 206 (FIG. 2) to indicate whether the analysis and evaluation should be performed either for the influence that the organization P to be evaluated, as defined at S300, has had on part of the organizations of the first through the “n”th organizations or for the influence the organization P has had on all the organizations, or whether the analysis should be performed either for only an organization that is influenced by the organization P or for the influence and how the influence is utilized.

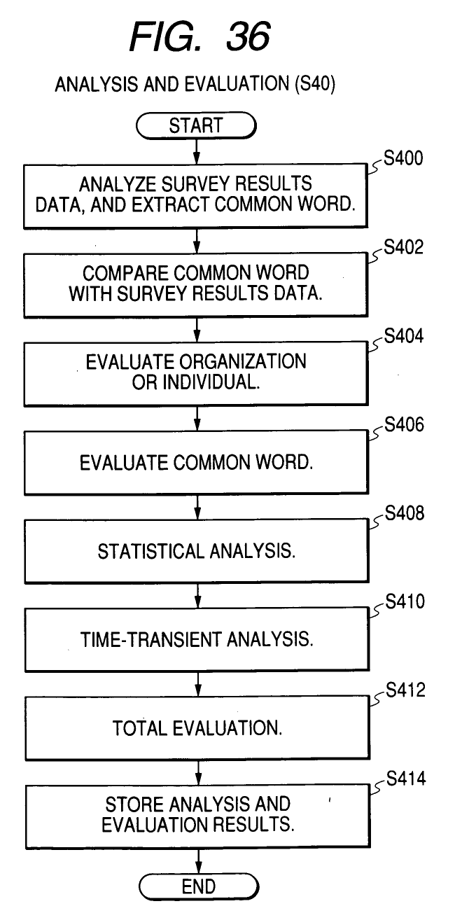

FIG. 36 is a diagram showing the analysis and evaluation processing (S40) in FIG. 35 that is performed by the analysis and evaluation unit 346 (FIG. 5).

In accordance with the user's designation, as is shown in FIG. 36, the analysis and evaluation unit 346 performs the analysis and evaluation processing and stores the obtained results in the analysis and evaluation result DB 348.

The UI unit 352 displays the analysis and evaluation results obtained at S40 on the display and input device 206, or uses the storage device 208 to store the results on a recording medium 210, such as a CD, a DVD, an FD or a portable HD.

As is shown in FIG. 36, at step 400 (S400), based on a the response received from the client computer 20 (FIG. 1), the analysis and evaluation unit 346 generates the survey result information shown in FIGS. 10 to 12 and 14.

Further, the analysis and evaluation unit 346 analyzes the generated survey result information, and extracts the common word and the concept (attribute) for each organization and each member, as explained while referring to FIG. 15.

At step 402 (S402), the analysis and evaluation unit 346 compares the survey result information obtained at S400 with the common word and the concept obtained at S400 for the organization or member to be evaluated.

At step 404 (S404), in accordance with the designation by the user, the analysis and evaluation unit 346 employs the comparison results obtained at S402 to evaluate the influence that the organization or member to be evaluated has had on the other organizations and members.

At step 406 (S406), in accordance with the designation by the user, the analysis and evaluation unit 346 evaluates the influence that the common word and the concept extracted for the organization or member to be evaluated has had on the other organizations and members.

At step 408 (S408), in accordance with the designation by the user, the analysis and evaluation unit 346 performs a statistical analysis of the evaluation results obtained at S404 and S406.

At step 410 (S410), in accordance with the designation by the user, the analysis and evaluation unit 346 performs a time series analysis of the evaluation results obtained at S404 and S406.

At step 412 (S412), in accordance with the designation by the user, the analysis and evaluation unit 346 performs a comprehensive evaluation of the evaluation results obtained at S404 and S406.

At step 414 (S414), the analysis and evaluation unit 346 stores, in the analysis and evaluation result DB 348, the analysis and evaluation results obtained through this processing. Then, in accordance with the manipulation performed by the user, the analysis and evaluation unit 346 uses the UI unit 352 to display various analysis and evaluation results that are thus stored to the display input device 206 (FIG. 2) (S310).

[Specific Examples]

According to the present invention, for each of the organizations that are included on a mailing list as part of a voluntary community that shares the information for discussing a company product, the strength of influence can be evaluated by analyzing all communications, including emails exchanged by the organizations that are developing the product, the data of voice recording of the meetings and chatting at office desks.

Further, according to the present invention, from three viewpoints, the propagation of information, the usage of the information for activities and the contribution of information to a psychological change, it can be understood how the contents of free discussions on the mailing list, concerning the mission of the entire company, have influenced all the communications exchanged by the employees.

According to the present invention, even for a specific person who, while on the mailing list in a company, remains silent (a so-called lurker), the influence that the mailing list for this person has on another organization can be evaluated, so long as he or she relays to others, via email, by phone or at an interview, information personally obtained through the mailing list, transfers an email to another mailing list, or introduces at a meeting a topic provided by the mailing list.

As is described above, according to the present invention, it is possible to evaluate the value of a virtual organization, such as an in-house mailing list for which the evaluation of the value is conventionally difficult.

Furthermore, according to the present invention, it is also possible to analyze and evaluate the value, such as the psychological influence an in-house mailing list provides participants, that can not be evaluated using a conventional method.

More specifically, according to the invention, the concepts (a word, a synonym, a sentence, a semantic network and the ontology) used for a specific mailing list and the concepts used for other than the mailing list are recorded, analyzed and evaluated. Therefore, it is possible to determine whether the concepts used for the mailing list are used for other than the mailing list.

An explanation for this will be given using an example mailing list for which the developer of a product X and a cross-section of the sales staff can participate and discuss everything about the product X.

Assume that many responses to, “New way to use a function Y of a specific product X, and its promotion to the market”, are obtained as activity content in the survey result information (FIG. 10) related to an activity. From the survey result information, the product X, the function Y and the promotion can be obtained as common words and concepts, and according to the invention, the number of organizations and the range influenced by the common words and the concepts can be acquired as the values for the common words and the concepts.

The evaluation of the values for the common word and the concept can be performed not only for the survey result information (FIG. 10) concerning the activity, but also for the survey result information (FIGS. 11 and 12) related to the data propagation and the change of thoughts of participants.

According to the invention, the research results of messages propagated between organizations can be analyzed, and the values of the organizations can be objectively evaluated.

Although the present invention has been shown and described with reference to a specific embodiment, various changes and modifications will be apparent to those skilled in the art from the teachings herein. Such changes and modifications as are obvious are deemed to come within the spirit, scope and contemplation of the invention as defined in the appended claims.

What is claimed is:

1. An evaluation apparatus for evaluating activities of a plurality of groups to be evaluated, the apparatus comprising:
an inquiry unit configured to direct inquiries to the plurality of groups concerning activities, each of the activities include one or more attributes, performed by the groups;
an attribute analysis unit configured to examine activity data included in responses received from the plurality of groups to which inquiries were directed, to analyze attributes that are used for the activities by the plurality of groups, and to generate attribute data that represent the attributes obtained as the result of the analysis; and
an evaluation unit configured to evaluate, based on the activity data and the attribute data, values of the activities, the attributes and the groups, or the values of one or more arbitrary combinations of the activities, the attributes and the groups.

2. The evaluation apparatus as claimed in claim 1, wherein the activity data include partner group data representing groups that have acted as partners for the activities, and activity contents data representing the contents of the activities,
wherein the attribute analysis unit analyzes the activity contents data included in the activity data, and generates the attribute data representing the attributes of the activities, and
wherein, based on either or both of the activity contents data and the attribute data, and the partner group data, the evaluation unit evaluates the number of groups that are influenced by either or both of the activities and the attributes, and the magnitude and the range of the influence, or the values of one or more arbitrary combinations of the number of groups, the magnitude of the influence, and the range of the influence.

3. The evaluation apparatus as claimed in claim 1, wherein the activities are propagation of information,
wherein the activity data include information recipient data representing recipient groups of information and information contents data representing the contents of the information that has been propagated,
wherein the attribute analysis unit analyzes the information content data included in the activity data, and generates the attribute data that represent the attribute of the information that has been propagated, and
wherein, based on either or both of the information content data and the attribute data, and the recipient group data, the evaluation unit evaluates the number of groups that are influenced by either or both of the information and the attributes, and the magnitude and the range of the influence, or the values of one or more arbitrary combinations of the number of groups, the magnitude of the influence, and the range of the influence.

4. The evaluation apparatus as claimed in claim 1, wherein the activities are psychological activities,
wherein the activity data include object group data representing objects for the psychological activities, and psychological activity contents data that represent the contents of the psychological activities,
wherein the attribute analysis unit analyzes the psychological activity content data included in the activity data, and generates the attribute data that represents the attributes of the psychological activities, and
wherein, based on either or both of the psychological activity contents data and the attribute data, and the object group data, the evaluation unit evaluates the number of groups that are influenced by either or both of the psychological activities and the attributes, the magnitude of the influence and the range of the influence, or the value of one or more arbitrary combinations of the number of groups, the magnitude of the influence and the range of the influence.

5. The evaluation apparatus as claimed in claim 1, wherein the plurality of groups are either or both of the members and the organizations that include one or more components.

6. An evaluation method for evaluating the activities of a plurality of groups comprising:
directing inquiries to the plurality of groups concerning activities, each of which includes one or more attributes and is performed by a group;
examining activity data that, in response to the inquiries, are included in responses received from the plurality of groups;
analyzing the attributes that are used for the activities performed by the plurality of groups;
generating attribute data that represent the attributes obtained by the analysis results; and
evaluating, based on the activity data and the attribute data, the values of the activities, the attributes and the groups, or the values of one or more arbitrary combinations of the activities, the attributes and the groups.

7. The evaluation method as claimed in claim 6, wherein the activity data include partner group data representing groups that have acted as partners for the activities, and activity contents data representing the contents of the activities, and
wherein the method further comprises:
analyzing the activity contents data included in the activity data;
generating the attribute data representing the attributes of the activities; and
evaluating, based on either or both of the activity contents data and the attribute data, and the partner group data, the number of groups that are influenced by either or both of the activities and the attributes, and the magnitude and the range of an influence, or the values of one or more arbitrary combinations of the number of groups, the magnitude of the influence, and the range of the influence.

8. The evaluation method as claimed in claim 6, wherein the activities are the propagation of information,
wherein the activity data include information recipient data representing recipient groups of information and information contents data representing the contents of the information that has been propagated, and
wherein the method further comprises:
analyzing the information content data included in the activity data;
generating the attribute data that represent the attribute of the information that has been propagated; and
evaluating, based on or either or both of the information content data and the attribute data, and the recipient group data, the number of groups that are influenced by either or both of the information and the attributes, and the magnitude and the range of an influence, or the values of one or more arbitrary combinations of the number of groups, the magnitude of the influence, and the range of the influence.

9. The evaluation method as claimed in claim 6, wherein the activities are psychological activities,
wherein the activity data include object group data representing objects for the psychological activities, and psychological activity contents data that represent the contents of the psychological activities, and
wherein the method further comprises:
analyzing the psychological activity content data included in the activity data;
generating the attribute data that represents the attributes of the psychological activities; and
evaluating, based on either or both of the psychological activity contents data and the attribute data, and the object group data, the number of groups that are influenced by either or both of the psychological activities and the attributes, the magnitude of an influence and the range of the influence, or the value of one or more arbitrary combinations of the number of groups, the magnitude of the influence and the range of the influence.

10. The evaluation method as claimed in claim 6, wherein the plurality of groups are either or both of the members and the organizations that include one or more components.

11. A program for computer to evaluate activities of a plurality of groups to be evaluated, the program making the computer to perform a process comprising:
directing inquiries to the plurality of groups concerning activities, each of which includes one or more attributes and is performed by a group;
examining activity data that, in response to the inquiries, are included in responses received from the plurality of groups;
analyzing the attributes that are used for the activities performed by the plurality of groups;
generating attribute data that represent the attributes obtained by the analysis results; and
evaluating, based on the activity data and the attribute data, the values of the activities, the attributes and the groups, or the values of one or more arbitrary combinations of the activities, the attributes and the groups.

12. The program as claimed in claim 11, wherein the activity data include partner group data representing groups that have acted as partners for the activities, and activity contents data representing the contents of the activities, and
wherein the program further making the computer to perform the process comprising:
analyzing the activity contents data included in the activity data;
generating the attribute data representing the attributes of the activities; and
evaluating, based on either or both of the activity contents data and the attribute data, and the partner group data, the number of groups that are influenced by either or both of the activities and the attributes, and the magnitude and the range of an influence, or the values of one or more arbitrary combinations of the number of groups, the magnitude of the influence, and the range of the influence.

13. The program as claimed in claim 11, wherein the activities are the propagation of information,
wherein the activity data include information recipient data representing recipient groups of information and information contents data representing the contents of the information that has been propagated, and
wherein the program further making the computer to perform the process comprising:
analyzing the information content data included in the activity data;
generating the attribute data that represent the attribute of the information that has been propagated; and
evaluating, based on or either or both of the information content data and the attribute data, and the recipient group data, the number of groups that are influenced by either or both of the information and the attributes, and the magnitude and the range of an influence, or one or more arbitrary combinations of the number of groups, the magnitude of the influence, and the range of the influence.

14. The program as claimed in claim 11, wherein the activities are psychological activities,
wherein the activity data include object group data representing objects for the psychological activities, and psychological activity contents data that represent the contents of the psychological activities, and
wherein the program further making the computer to perform the process comprising:
analyzing the psychological activity content data included in the activity data;
generating the attribute data that represents the attributes of the psychological activities; and
evaluating, based on either or both of the psychological activity contents data and the attribute data, and the object group data, the number of groups that are influenced by either or both of the psychological activities and the attributes, the magnitude of an influence and the range of the influence, or the value of one or more arbitrary combinations of the number of groups, the magnitude of the influence and the range of the influence.

15. The program as claimed in claim 11, wherein the plurality of groups are either or both of the members and the organizations that include one or more components.
